(19) United States
(12) Patent Application Publication
(10) Pub. No.: US 2023/0318026 A1
(43) Pub. Date: Oct. 5, 2023

(54) METHOD FOR MANUFACTURING POSITIVE ELECTRODE MATERIAL

(71) Applicant: HONDA MOTOR CO., LTD., Tokyo (JP)

(72) Inventors: Yui KINOSHITA, Saitama (JP); Satoshi AOKI, Saitama (JP); Makoto TANAKA, Saitama (JP); Rio KOYAMA, Saitama (JP)

(73) Assignee: HONDA MOTOR CO., LTD., Tokyo (JP)

(21) Appl. No.: 18/121,271

(22) Filed: Mar. 14, 2023

(30) Foreign Application Priority Data
Mar. 31, 2022 (JP) 2022-059147

(51) Int. Cl. H01M 10/0562; H01M 4/62; H01M 4/02

(52) U.S. Cl. CPC H01M 10/0562; H01M 4/624; H01M 2300/0071; H01M 2004/028

(57) ABSTRACT

A method for manufacturing a positive electrode material of a solid-state battery, the method includes a first compositing to mix a positive electrode active material with a solid electrolyte to generate a first powder, and a second compositing to mix the solid electrolyte with the first powder under a stirring condition different from a stirring condition in the first compositing to generate a second powder. According to the method, it is possible to reduce the amount of a dispersion medium when generating a slurry in manufacturing the positive electrode material.

### CROSS-REFERENCE TO RELATED APPLICATIONS

The present application claims the benefit of priority of Japanese Patent Application No. 2022-059147, filed on Mar. 31, 2022, the content of which is incorporated herein by reference.

### TECHNICAL FIELD

The present invention relates to a method for manufacturing a positive electrode material.

### BACKGROUND ART

in recent years, researches and development on secondary batteries that contribute to energy efficiency have been carried out to ensure access to convenient, reliable, sustainable, and advanced energy for more people.

As a secondary battery, a lithium ion secondary battery is widely used. A lithium ion secondary battery using a liquid as an electrolyte has a structure in which a separator is present between a positive electrode and a negative electrode and filled with a liquid electrolyte (electrolytic solution).

Since the electrolytic solution of the lithium ion secondary battery is usually a combustible organic solvent, there have been cases where the safety against heat has become a problem. Therefore, a solid-state battery using a flame-retardant solid electrolyte instead of the organic liquid electrolyte has also been proposed.

A solid-state secondary battery includes an inorganic solid electrolyte, an organic solid electrolyte, or a gel-like solid electrolyte as an electrolyte layer between a positive electrode and a negative electrode. In a solid-state battery using a solid electrolyte, as compared with a battery using an electrolytic solution, the problem caused by heat can be solved, the capacity can be increased and/or the voltage can be increased, and the demand for compactness can also be met.

Various methods for manufacturing a positive electrode material for such a lithium ion secondary battery have been proposed (for example, refer to WO2020/174868A1, JP2011-65887A, JP2016-42417A and WO2012/001808A1). For example, WO2020/174868A1 describes forming secondary particles by mixing a sulfide-based solid electrolyte with positive electrode active material particles coated with an oxide-based solid electrolyte. A positive electrode of a secondary battery is generally prepared by mixing a positive electrode active material, a solid electrolyte, and a dispersion medium containing a binder to form a slurry, coating a current collector with the slurry, and performing drying.

### SUMMARY OF INVENTION

Here, in the step of generating the slurry, it is preferable that an amount of the dispersion medium is small. When the amount of the dispersion medium is reduced, the manufacturing cost can be reduced and the manufacturing time can be shortened. As a result of intensive examination of the present inventor, it is necessary to reduce a total surface area of all materials by compositing the positive electrode active material and the solid electrolyte in order to reduce the amount of the dispersion medium, and therefore, there is room for improvement in the method in the related art.

The present embodiment provides a method for manufacturing a positive electrode material, which can reduce an amount of a dispersion medium when generating a slurry. The present embodiment contributes to improvement in energy efficiency.

The present embodiment provides a method for manufacturing a positive electrode material of a solid-state battery, the method including:
a first compositing step of mixing a positive electrode active material with a solid electrolyte to generate a first powder; and
a second compositing step of mixing the solid electrolyte with the first powder under a stirring condition different from a stirring condition in the first compositing step to generate a second powder.

According to the present invention, it is possible to reduce the amount of the dispersion medium when generating the slurry in manufacturing the positive electrode material.

### BRIEF DESCRIPTION OF DRAWINGS

FIG. 1 is a cross-sectional view of a solid-state battery 1.

FIG. 2 is a flow diagram schematically showing a method for manufacturing a positive electrode material.

FIG. 3 is a table showing experimental results in Example and Comparative Examples 1 and 2.

FIG. 4 is a schematic diagram showing a state of particles dispersed in a slurry.

### DESCRIPTION OF EMBODIMENTS

First, a solid-state battery using a positive electrode material manufactured by a manufacturing method according to the present invention will be described.

### [Solid-State Battery]

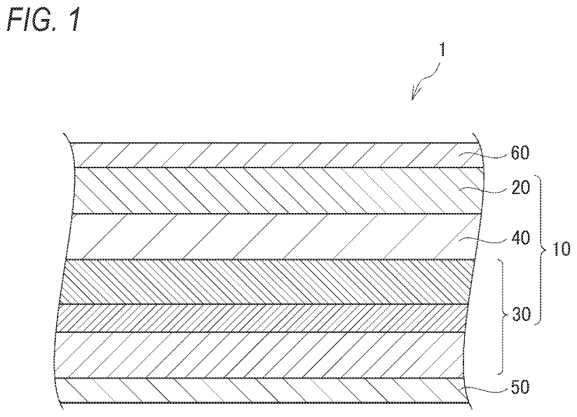

As shown in FIG. 1, a solid-state battery 1 includes a battery body 10, a negative electrode current collector 50, and a positive electrode current collector 60. Note that in the present description, the solid-state battery refers to a fully solid-state battery.

The negative electrode current collector 50 and the positive electrode current collector 60 are conductive plate-shaped members that sandwich the battery body 10 from both sides. The negative electrode current collector 50 has a function of collecting a current from a negative electrode layer 30, and the positive electrode current collector 60 has a function of collecting a current from a positive electrode layer 20. The battery body 10 includes the positive electrode layer 20 functioning as a positive electrode, the negative electrode layer 30 functioning as a negative electrode, and a conductive solid electrolyte layer 40 positioned between the positive electrode layer 20 and the negative electrode layer 30. The positive electrode layer 20 is manufactured by coating the positive electrode current collector 60 with a slurry containing a positive electrode active material as a positive electrode material, a conductive aid, and a solid electrolyte, and performing drying.

[Method for Manufacturing Positive Electrode Material]

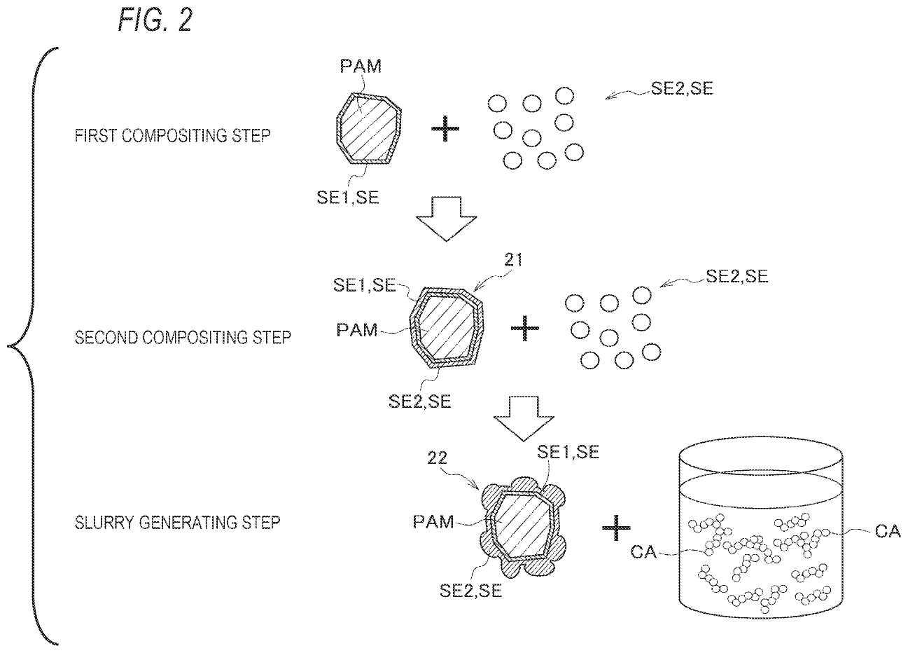

Hereinafter, a method for manufacturing a positive electrode material according to an embodiment of the present invention will be described with reference to FIG. 2.

The method for manufacturing a positive electrode material includes the following steps.
1. a first compositing step of mixing a positive electrode active material PAM with a solid electrolyte SE to generate a first powder 21
2. a second compositing step of mixing the solid electrolyte SE with the first powder 21 under a stirring condition different from a stirring condition in the first compositing step to generate a second powder 22
3. a slurry generating step of mixing the second powder 22 with a dispersion medium containing a conductive aid CA, a solvent, and a binder
4. a slurry coating step of coating a current collector with a slurry

The method for manufacturing a positive electrode material according to the present embodiment is different from a manufacturing method in the related art in which a sulfide-based solid electrolyte is mixed with positive electrode active material particles coated with an oxide-based solid electrolyte to form secondary particles (composites). In the manufacturing method in the related art, by forming secondary particles (composites), a total surface area of the particles is smaller than a case where secondary particles (composites) are not formed, and an amount of a dispersion medium can be reduced, but the amount of the dispersion medium is still large and there is room for improvement.

Therefore, in the method for manufacturing a positive electrode material according to the present embodiment, as shown in FIG. 2, the solid electrolyte SE is mixed with the positive electrode active material PAM in a dry method, and the surface of the positive electrode active material PAM is coated with the solid electrolyte SE to generate the first powder 21. In the first powder 21, the solid electrolyte SE adheres to the surface of the positive electrode active material PAM. Then, the solid electrolyte SE is mixed with the obtained first powder 21 in a dry method to fix the solid electrolyte SE in a form of being supported on the first powder 21. In the second powder 22, the solid electrolyte SE is attached to the surface of the positive electrode active material PAM to which the solid electrolyte SE adheres (the surface of the solid electrolyte SE). In this way, when both a dense adhesion state and a rough attachment state of the solid electrolyte SE to the positive electrode active material PAM are achieved, both conduction paths for electrons and lithium ions (Li*) can be achieved while ensuring a contact area between the positive electrode active material PAM and the solid electrolyte SE (a sulfide-based solid electrolyte SE2 to be described later). Insufficient compositing results in a large surface area of particles, resulting in a large amount of dispersion medium necessary for slurrying, while sufficient compositing can reduce the amount of the dispersion medium.

In the particles that have undergone the first compositing step, the positive electrode active material PAM serves as mother particles and the solid electrolyte SE serves as child particles, and the surface of the mother particles is coated with the child particles in the form of a thin film (first powder). In the particles that have undergone the second compositing step, the first powder serves as mother particles and the solid electrolyte SE serves as child particles, and the child particles are attached to the surface of the mother particles while maintaining a particle form (second powder). Compositing means that the van der Waals force due to a difference in particle size acts between child particles having a small particle size and mother particles having a large particle size, which are obtained by crushing and dispersing aggregates of respective materials with a shear stress above a certain level, to form composite particles. Hereinafter, particles mixed through the first compositing step and the second compositing step may be referred to as composite particles.

In order to separate the compositing step, when the originally necessary amount of the solid electrolyte SE is set to 1, ½ of the solid electrolyte SE is mixed with the positive electrode active material PAM in the first compositing step, and ½ of the solid electrolyte SE is mixed with the first powder in the second compositing step. Note that the proportion of the solid electrolyte SE mixed in the first compositing step and the second compositing step can be changed as appropriate.

Then, in the composite particles in which the solid electrolytes SE are bonded to the positive electrode active material PAM in a dense adhesion state and a rough attachment state, the total surface area is reduced. Accordingly, the amount of the dispersion medium necessary for slurrying, that is, the amount of the solvent and the binder can be reduced. When the composited particles are brought into a dispersed state in advance, the time necessary for dispersion in the slurrying can be shortened. In addition, when the amount of the solvent is reduced, the drying time after coating with the slurry can be shortened. Further, when the amount of the binder is reduced, the resistance of the electrode can be reduced. Note that the dry method means mixing without using a dispersion medium. Hereinafter, respective steps will be described in detail.

[First Compositing Step]

In the first compositing step, the positive electrode active material PAM is mixed with the solid electrolyte SE in a dry method to generate the first powder 21.

Examples of the positive electrode active material PAM include oxides containing lithium and cobalt as constituent metal elements, and oxides containing at least one other metal element other than lithium and cobalt as constituent metal elements. Examples of the metal element other than lithium and cobalt include Ni, Mn, Al, Cr, Fe, V, Mg, Ca, Na, Ti, Zr, Nb, Mo, W, Cu, Zn, Ga, In, Sn, La, and Ce. These may be contained alone or in combination of two or more thereof.

Examples of the positive electrode active material PAM include LiCoO₂. In addition, examples thereof include a lithium nickel cobalt manganese-based oxide (NCM) represented by the following general formula (1). The NCM is preferred in term of a high energy density per volume and excellent thermal stability.

LiNiₐCo_{b}Mn_{c}O₂ (1)

(In the formula, 0<a<0<b<, 0<c<1, and a+b+c=1.)

In addition, examples of the positive electrode active material PAM include a lithium nickel cobalt aluminum-based oxide (NCA) represented by the following general formula (2).

LiₜNi_{1-x-y}CoₓAl_{y}O₂ (2)

(In the formula, 0.95≤t≤1.15, 0≤x≤0.3, 0.1≤y≤0.2, and x+y<0.5.)

The surface of the positive electrode active material PAM is preferably coated in advance with an oxide-based solid electrolyte. When the surface of the positive electrode active material PAM is coated with an oxide-based solid electrolyte, the interfacial resistance between the positive electrode active material PAM and the oxide-based solid electrolyte in contact therewith can be reduced, and the ion conductivity can be improved.

Note that the coating with the oxide-based solid electrolyte is preferably in the form of a film without particle boundaries and coats the entire surface of the positive electrode active material. Accordingly, the particle boundary resistance of particles after coating can be reduced. Such a particle boundary-free film-like coating layer is formed by spray coating, for example.

Examples of the oxide-based solid electrolyte include LiNbO₃ in the case of a lithium ion battery. In addition, examples thereof include a NASICON type oxide, a garnet type oxide, and a perovskite type oxide. Examples of the NASICON type oxide include an oxide containing Li, Al, Ti, P, and O (such as Li_{1.5}Al_{0.5}Ti_{1.5}(PO₄)₃). Examples of the garnet type oxide include an oxide containing Li, La, Zr, and O (such as Li₇La₃Zr₂O₁₂). Examples of the perovskite type oxide include an oxide containing Li, La, Ti, and O (such as LiLaTiO₃). Note that it is not always necessary to coat the surface of the positive electrode active material PAM with an oxide-based solid electrolyte.

Examples of the solid electrolyte SE include a sulfide-based solid electrolyte. A sulfide-based solid electrolyte material usually contains a metal element (M) to be conductive ions and sulfur (S). Examples of the M include Li, Na, K, Mg, and Ca. Among these, Li is preferred. In particular, the sulfide-based solid electrolyte material preferably contains Li, A (A is at least one selected from the group consisting of P, Si, Ge, Al, and B), and S. The A is preferably P (phosphorus). Further, the sulfide-based solid electrolyte material may contain halogens such as Cl, Br, and I. This is because containing halogens improves the ion conductivity. In addition, the sulfide-based solid electrolyte material may contain O.

Examples of the sulfide-based solid electrolyte material having Li ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is any one of Ge, Zn, and Ga), Li₂S—GeS₂, Li₂S—SiS₂—Li₃PO₄, and Li₂S—SiS₂-LiₓMO_{y} (where x and y are positive numbers, and M is any one of P, Si, Ge, B, Al, Ga, and In). Note that the description of “Li₂S—P₂S₅” means a sulfide-based solid electrolyte material formed using a raw material composition containing Li₂S and P₂S₅, and the same applies to other descriptions.

In the following description, of the solid electrolytes SE, the oxide-based solid electrolyte is referred to as SE1, and the sulfide-based solid electrolyte as SE2, which are described in a distinguished way. As shown in an upper part in FIG. 2, in the first compositing step, the surface of the positive electrode active material PAM or the surface of the positive electrode active material PAM coated with the oxide-based solid electrolyte SE1 (the surface of the oxide-based solid electrolyte SE1) is coated with the sulfide-based solid electrolyte SE2, and adheres to the sulfide-based solid electrolyte SE2. In order to form such a dense sulfide-based solid electrolyte layer, a compositing treatment accompanied by a high shear force is necessary. The compositing treatment accompanied by a high shear force means a mixing treatment by high-speed stirring.

In the mixing treatment by high-speed stirring, a mixer is rotated at a high speed. For the stirring speed, a peripheral speed of 60 m/s to 100 m/s is preferred, and a peripheral speed of 70 m/s to 80 m/s is more preferred. In addition, the stirring time is preferably 50 minutes to 70 minutes, more preferably 55 minutes to 65 minutes, and most preferably about 60 minutes.

[Second Compositing Step]

In the second compositing step, as shown in a middle part in FIG. 2, the first powder 21 obtained in the first compositing step is mixed with the sulfide-based solid electrolyte SE2 in a dry method to generate the second powder 22. Here, the mixing treatment in the second compositing step is performed under stirring conditions different from those in the mixing treatment in the first compositing step. That is, a compositing treatment accompanied by a lower shear force than that in the first compositing step is performed. The compositing treatment accompanied by a lower shear force means a mixing treatment by low-speed stirring and medium-speed stirring.

In the mixing treatment in the second compositing step, the mixer is rotated at a medium to high speed. For the stirring speed, a peripheral speed of 40 m/s to 80 m/s is preferred, and a peripheral speed of 60 m/s to 70 m/s is more preferred. In addition, the stirring time is preferably 30 minutes or shorter, and more preferably 20 minutes or shorter.

Comparing the first compositing step with the second compositing step, the second compositing step has a stirring speed slower than that in the first compositing step. In other words, the second compositing step has a shear force lower than that in the first compositing step. In addition, the second compositing step has a stirring time shorter than that in the first compositing step. Accordingly, the surface of the positive electrode active material PAM can be coated with the sulfide-based solid electrolyte SE2 in the first compositing step, and the particles generated in the first compositing step can support the bulky sulfide-based solid electrolyte SE2 in the second compositing step. In addition, the particle size of the bulky sulfide-based solid electrolyte SE2 can be prevented from becoming small.

[Slurry Generating Step]

In the slurry generating step, as shown in a lower part in FIG. 2, the second powder 22 is mixed with a dispersion medium (auxiliary dispersion medium) containing a conductive aid CA, a solvent, and a binder.

The solvent is not particularly limited, and examples thereof include organic solvents such as N-methyl-2-pyrrolidone (NMP), toluene, or alcohols, and water.

Examples of the conductive aid CA include acetylene black, carbon nanotubes, graphene, and graphite particles.

Examples of the binder include polyvinylidene fluoride (PVDF), polyvinylidene chloride (PVDC), polyethylene oxide (PEO), polypropylene oxide (PPO), and a polyethylene oxide-propylene oxide copolymer (PEO-PPO).

[Slurry Coating Step]

As the slurry coating step, a known method can be applied. Examples thereof include methods such as roller coating such as applicator roll, screen coating, blade coating, spin coating, and bar coating.

Note that, in the positive electrode material of the solid-state battery manufactured by the manufacturing method according to the present invention, the positive electrode layer may be formed on at least one side of the current collector, and may be formed on both sides of the current collector. It can be appropriately selected depending on the type and the structure of the intended solid-state battery. Note that, after coating the current collector with the slurry, there may be steps such as drying and rolling.

[Example Related to Reduction in Amount of Dispersion Medium]

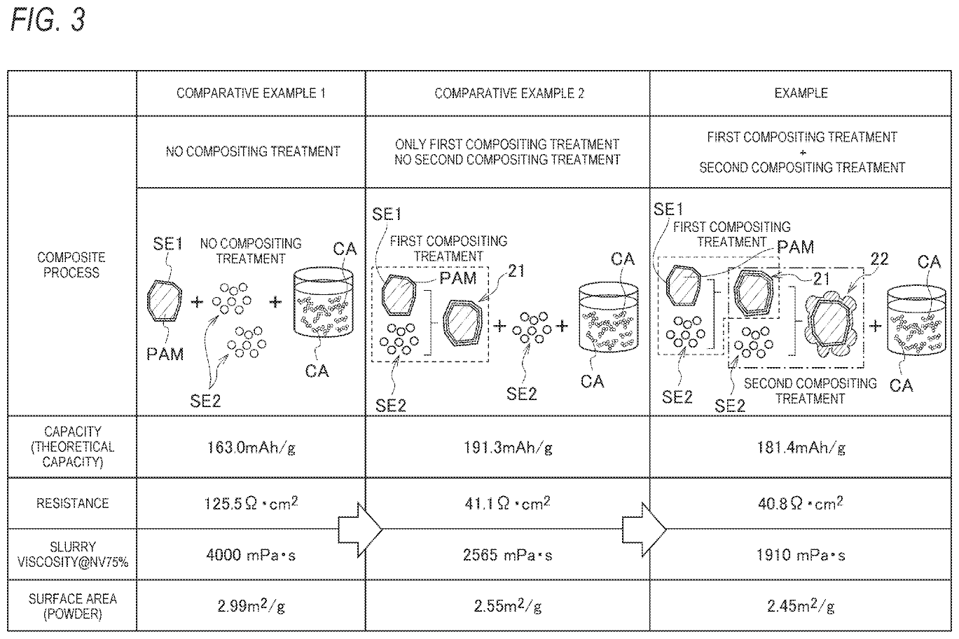

FIG. 3 is a table showing experimental results of comparing battery capacity (theoretical capacity), resistance, slurry viscosity, and powder surface area in Example of the present invention and two Comparative Examples.

The Example is a positive electrode material manufactured by the method for manufacturing a positive electrode material described above. That is, it is a positive electrode material formed of a slurry obtained by dispersing, in a dispersion medium (the conductive aid CA, the solvent, and the binder), the second powder 22 obtained through the first compositing step and the second compositing step. Comparative Example 1 (no compositing treatment) is a positive electrode material formed of a slurry obtained by dispersing, in a dispersion medium (the conductive aid CA, the solvent, and the binder), the sulfide-based solid electrolyte SE2 and the positive electrode active material PAM coated with the oxide-based solid electrolyte SE1 without a compositing treatment. Comparative Example 2 (only first compositing treatment+no second compositing treatment) is a positive electrode material formed of a slurry obtained by dispersing, in a dispersion medium (the conductive aid CA, the solvent, and the binder), the first powder 21 obtained by compositing the sulfide-based solid electrolyte SE2 and the positive electrode active material PAM coated with the oxide-based solid electrolyte SE1 in the first compositing step, and the sulfide-based solid electrolyte SE2 without a compositing treatment. Note that the sulfide-based solid electrolyte SE2 and the positive electrode active material PAM coated with the oxide-based solid electrolyte SE1 are the same and in the same amount in both Example and Comparative Examples 1 and 2.

The battery capacity is a theoretical value of battery capacity per 1 g of the positive electrode active material. The slurry viscosity is the degree of stickiness of a substance. Since the slurry viscosity changes according to the shear rate, in the present disclosure, the viscosity means the viscosity at a shear rate of about 75 [l/s]. The resistance is the internal resistance at the positive electrode. As for the resistance of the positive electrode, it is desirable that the contact area between the positive electrode active material and the sulfide-based solid electrolyte is large, and that the conduction paths for electrons and lithium ions (Li⁺) are sufficiently formed throughout the positive electrode. In such a case, the resistance becomes small. The solvent in the dispersion medium is an unnecessary material that evaporates and flies off after coating with the slurry. The smaller the surface area, the smaller the contact area with the dispersion medium. Therefore, the amount of the dispersion medium can be reduced.

From the experimental results in FIG. 3, Comparative Example 2 showed better results in all items than Comparative Example 1. Further, Example showed better results in all items than Comparative Example 2.

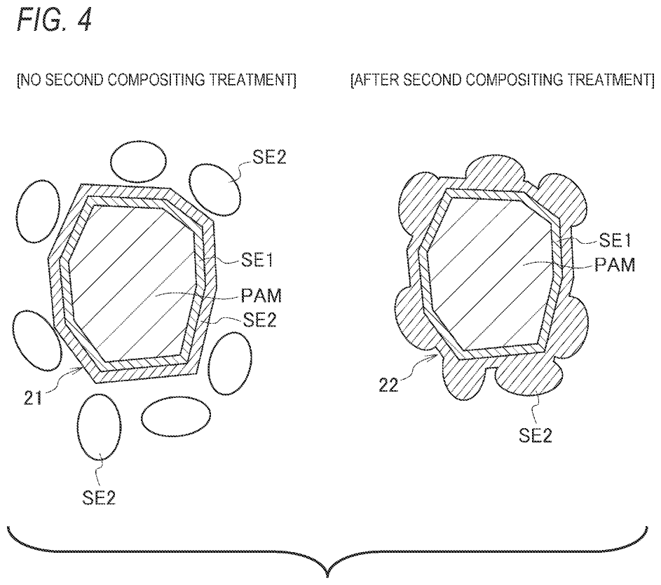

FIG. 4 is a schematic diagram showing a state of particles dispersed in a slurry. In no second compositing treatment (Comparative Example 2), the first powder 21, in which the surface of the particles of the positive electrode active material PAM coated with the oxide-based solid electrolyte SE1 is coated with the sulfide-based solid electrolyte SE2, and the sulfide-based solid electrolyte SE2 are present in the dispersion medium in a discrete state, so that the total surface area of the powder increases, and the necessary amount of the dispersion medium increases. On the other hand, after the second compositing treatment (in Example), the sulfide-based solid electrolyte SE2 is attached in bulk to the surface of the first powder 21, so that the total surface area of the powder is reduced, and the necessary amount of the dispersion medium is reduced.

In this way, according to the method for manufacturing a positive electrode material of the present invention, the surface of the positive electrode active material PAM can be coated with the solid electrolyte SE in the first compositing step, the particles generated in the first compositing step can support the bulky solid electrolyte SE in the second compositing step, and both a dense adhesion state and a rough attachment state of the solid electrolyte SE can be achieved. Accordingly, both conduction paths for electrons and lithium ions (Li⁺) can be achieved while ensuring a contact area between the positive electrode active material PAM and the solid electrolyte SE (solid electrolyte SE2). In addition, since the total surface area of the particles constituting the electrode can be reduced, the amount of the dispersion medium necessary for slurrying can be reduced.

Although various embodiments are described above with reference to the drawings, it is needless to say that the present invention is not limited to such examples. It will be apparent to those skilled in the art that various changes and modifications may be conceived within the scope of the claims. It is also understood that the various changes and modifications belong to the technical scope of the present invention. Components in the embodiment described above may be combined freely within a range not departing from the spirit of the invention.

In the present description, at least the following matters are described. Note that although the corresponding constituent elements or the like in the above-described embodiments are shown in parentheses, the present invention is not limited thereto.

(1) A method for manufacturing a positive electrode material of a solid-state battery (solid-state battery 1), the method including:
a first compositing step of mixing a positive electrode active material (positive electrode active material PAM) with a solid electrolyte (solid electrolyte SE) to generate a first powder (first powder 21); and
a second compositing step of mixing the solid electrolyte with the first powder under a stirring condition different from a stirring condition in the first compositing step to generate a second powder (second powder 22).

According to (1), by mixing the solid electrolyte with the positive electrode active material in two stages while changing the stirring condition, two types of solid electrolyte layers can be wrapped around the positive electrode active material. Accordingly, the contact area of the second powder with the dispersion medium is reduced when making a slurry by compositing the particles, so that the amount of the dispersion medium necessary for generating the slurry can be reduced.

(2) The method for manufacturing a positive electrode material according to (1), in which
the second compositing step has a stirring speed slower than a stirring speed in the first compositing step.

According to (2), the surface of the positive electrode active material can be coated with the solid electrolyte in the first compositing step, and the particles generated in the first compositing step can support the bulky solid electrolyte in the second compositing step. In this way, when both a dense adhesion state and a rough attachment state of the solid electrolyte are achieved, both conduction paths for electrons and ions can be achieved while ensuring a contact area between the positive electrode active material and the solid electrolyte. In addition, since the total surface area of the particles constituting the electrode can be reduced, the amount of the dispersion medium necessary for slurring can be reduced.

(3) The method for manufacturing a positive electrode material according to (1) or (2), in which
the second compositing step has a shear force smaller than a shear force in the first compositing step.

According to (3), the surface of the positive electrode active material can be coated with the solid electrolyte in the first compositing step, and the particles generated in the first compositing step can support the bulky solid electrolyte in the second compositing step. In this way, when both a dense adhesion state and a rough attachment state of the solid electrolyte are achieved, both conduction paths for electrons and ions can be achieved while ensuring a contact area between the positive electrode active material and the solid electrolyte. In addition, since the total surface area of the particles constituting the electrode can be reduced, the amount of the dispersion medium necessary for slurrying can be reduced.

(4) The method for manufacturing a positive electrode material according to (2) or (3), in which
the second compositing step has a stirring time shorter than a stirring time in the first compositing step.

According to (4), the particle size of the bulky solid electrolyte can be prevented from becoming small.

(5) The method for manufacturing a positive electrode material according to any one of (1) to (4), in which
the positive electrode active material is coated with another solid electrolyte different from the solid electrolyte.

According to (5), the positive electrode active material can be protected.

(6) The method for manufacturing a positive electrode material according to (5), in which
the solid electrolyte is a sulfide-based solid electrolyte (sulfide-based solid electrolyte SE2), and
the another solid electrolyte is an oxide-based solid electrolyte (oxide-based solid electrolyte SE1).

According to (6), the interfacial resistance between the positive electrode active material and the oxide-based solid electrolyte can be reduced, and the ion conductivity can be improved.

(7) The method for manufacturing a positive electrode material according to any one of (1) to (6), further including:
a slurry generating step of mixing the second powder with an auxiliary dispersion medium containing a conductive aid (conductive aid CA).

According to (7), a slurry can be generated with a small amount of dispersion medium.

What is claimed is:

1. A method for manufacturing a positive electrode material of a solid-state battery, the method comprising:
a first compositing to mix a positive electrode active material with a solid electrolyte to generate a first powder; and
a second compositing to mix the solid electrolyte with the first powder under a stirring condition different from a stirring condition in the first compositing to generate a second powder.

2. The method for manufacturing a positive electrode material according to claim 1, wherein
the second compositing has a stirring speed slower than a stirring speed in the first compositing.

3. The method for manufacturing a positive electrode material according to claim 1, wherein
the second compositing has a shear force smaller than a shear force in the first compositing.

4. The method for manufacturing a positive electrode material according to claim 2, wherein
the second compositing has a stirring time shorter than a stirring time in the first compositing.

5. The method for manufacturing a positive electrode material according to claim 1, wherein
the positive electrode active material is coated with another solid electrolyte different from the solid electrolyte.

6. The method for manufacturing a positive electrode material according to claim 5, wherein
the solid electrolyte is a sulfide-based solid electrolyte, and
the another solid electrolyte is an oxide-based solid electrolyte.

7. The method for manufacturing a positive electrode material according to claim 1, further comprising:
a slurry generating to mix the second powder with an auxiliary dispersion medium containing a conductive aid.
